(19) United States
(12) Patent Application Publication
(10) Pub. No.: US 2015/0044326 A1
(43) Pub. Date: Feb. 12, 2015

(54) COMPOSITION COMPRISING A MIXTURE OF FIBERS

(71) Applicants: Guilherme Padua Rodrigues, Sao Paulo (BR); Fernanda Junqueira De Castro, Sao Paulo (BR)

(72) Inventors: Guilherme Padua Rodrigues, Sao Paulo (BR); Fernanda Junqueira De Castro, Sao Paulo (BR)

(21) Appl. No.: 14/116,921

(22) PCT Filed: May 14, 2012
(86) PCT No.: PCT/BR2012/000140

§ 371 Date: Apr. 28, 2014

(30) Foreign Application Priority Data
May 13, 2011 (BR) PCT/BR2011/000150

(51) Int. Cl. A23L 1/308; A23L 1/29

(52) U.S. Cl. CPC A23L 1/308; A23L 1/293; A23V 2002/00
USPC 426/2; 426/71; 426/658

(57) ABSTRACT

The present invention relates to compositions comprising fibers, suitable as food compositions. The present invention also relates to the use to such compositions for digestive comfort. The fibers comprise fructo-oligosaccharide, resistant dextrin or maltodextrin, and polydextrose.

The present invention relates to compositions comprising fibers suitable as food compositions. The present invention also relates to the use to such compositions for digestive comfort.

Fibers are commonly used in food products. Fibers are non digestible compounds that undergo fermentation by the bacteria present in the colon (also referred to intestinal flora, microflora or microbiota). Some fibers are believed to provide functional benefits. Fructo-oligosaccharide fibers have been described as improving stool frequency. Polydextrose fibers have been described as providing satiety or cardiovascular benefits. Resistant dextrin or maltodextrin fibers have been described as providing some digestive effects. Fibers are at least perceived as having a benefic effect on digestion.

For example some literature provides that an amount of 8 g of fibers per day is appropriate to provide a health effect on population presenting slow transit time and/or a low stool frequency. However ingestion of such amounts would generate a significant change is diet habits of most populations, and ingestion of functional food products highly loaded with fibers can create some intolerance. Indeed fibers can provide some undesired side effects such as bloating, flatulence and/or laxative effects. It is believed that such bloating and/or flatulence can be linked to gas production in the colon. There is a need for fiber compositions that provide a good tolerance even at significant concentration.

Documents BR PI 0514301-2 A and WO 2006/015880 describe food compositions comprising a mixture of FOS, maltodextrin, and polydextrose. In the mixture the amount by weight of polydextrose is of higher than 50%. The fiber composition is said to allow sugar replacement and thus to allow a sweetening action. However this document is mute about digestion and side effects, and such fibers compositions with high amounts of polydextrose are believed to provide poor benefits on digestion. There is a need for other fibers compositions that can provide a better action on digestion and/or that can limit side effects.

Usage of fibers can be limited by some undesired side effects, for example high gas production in the colon. Tolerance to food compositions comprising high amounts of fibers can be impacted. Therefore there is a need for compositions that comprise fibers and mitigate potential side effects, when orally ingested.

The invention addresses at least one of the needs or problems above with a composition comprising a mixture of the following fibers a), b) and c):
fiber a): Fructo-oligosaccharide,
fiber b): resistant dextrin or maltodextrin
fiber c): Polydextrose,
   wherein the relative amounts by weight of fibers a), b) and c), with reference to the total amount by weight of fibers a), b) and c) are as follows:
from 1% to 98% of fiber a),
from 1% to 98% of fiber b), and
from 1% to 50% of fiber c),
   the total amount of fibers a), b) and c) being 100%.

Without intending to be bound by any theory, it is believed that the different fibers of the invention can ferment in the colon at different location and/or with different kinetics and thus can exert complementary physiological effects with low side effects. For example the slower the fiber is fermented, the closer to the final portions of the colon it can reach and therefore, impact. Thus it is believed that high total amounts of fibers can be delivered, but with a diluted potential side effect compared to a big amount of a single fiber. It is believed thus that the consumer can have fiber fermentation during a longer period without being impacted with a big amount of by-products that can cause side effects such as sudden lowering of the intestinal pH and/or gas production and consequently diarrhea, flatulence, abdominal distension and/or pain. It is believed that the progressive effect of the fibers association of the invention can lead to a more constant bowel movement and more comfortable final benefit.

Some effects can be observed on in-vivo subjects. Some effects can be observed on in-vitro tests simulating digestion in the colon. The association of fibers can present a synergy on the colon pH, reducing the pH drop during digestion, on the volume of gas produced (the lower the better), on the kinetic and/or localization of the production of gas, on the production of short chain fatty acids, such as acetate, propionate and/or butyrate (the higher the better), on the kinetics and/or localization of the production of such short chain fatty acids, on the production of lactic acid, and/or on the on the kinetics and/or localization of the production of lactic acid.

### COMPOSITION

The composition according to the invention comprises fibers a), b), and c). The composition typically also comprises a matrix, wherein the fibers are dispersed. The matrix can be in a liquid form, in a paste form, or in a solid form. The matrix is preferably in a liquid form. The matrix can be for example a fruit juice, a dairy product, a carbonated or non carbonated beverage, a frozen product or a solid food product. Thus the composition can be a fruit juice, a dairy product, a carbonated or non carbonated beverage, a frozen product or a solid food product.

The composition can be a fruit juice, typically comprising a fruit extract, typically as the matrix of the composition. Herein fruit juices refer to any product comprising fruits or fruit extracts, such as fruit juices, nectars, smoothies.

Examples of suitable fruit juices include orange fruit juice, peach fruit juice, grape fruit juice, apple fruit juice, mango fruit juice, exotic fruits fruit juice, strawberry fruit juice, red fruits fruit juice, banana fruit juice, and mixtures of fruit juices comprising at least one of these fruit juices. Fruit juices are known by the one skilled in the art. One can for example use fruit juices with fruit pulp or without fruit pulp. One can use for example “NFC” (Not From Concentrate) fruit juice or fruit juice produced from concentrates, wherein water is typically added. One can for example use frozen concentrate fruit juice and optionally add water. One can for example use fruit juices with various Brix degrees, for example with a Brix degree of from higher than 0 to 20 Brix, or of from higher than 20 to 55 Brix, or of from higher than 55 to 99 brix. Preferred fruit juices have a Brix degree of from 10 to 20, for example of from 10 to 12 or of from 12 to 15 or of from 15 to 20. Some fruit juice can have a brix degree of from 5 to 10.

Fruit juice compositions can include some ingredients further to fruits or fruits extracts, for example sugar, sweeteners, flavors, coloring agents, stabilizers, viscosifying agents such as starches or xanthan gum, pH modifying agents such as citric acid or ascorbic acid, etc. Fruit juice compositions can typically present a pH of from 3 to 4.5. In one embodiment the composition does not comprise further fibers, different than fibers a), b), and c). In one embodiment the composition comprises further fibers, different from fibers a), b), and c).

The matrix, typically a fruit juice, usually comprises water. The dry matter in the matrix (excluding fibers) can be typically of from 5 to 20% by weight, for example of from 5 to 10%, or of from 10 to 12% or of from 12 to 15% or of from 15 to 20%. The amount of water, of optional further ingredients, and the Brix degree can be easily adapted by the one skilled in the art.

The dry matter in the composition (including fibers) can be typically of from 7 to 22% by weight, for example of from 7 to 12%, or of from 12 to 14% or of from 14 to 17% or of from 17 to 22%. The amount of water, of fibers, of optional further ingredients and the Brix degree can be easily adapted by the one skilled in the art.

In one embodiment the composition is a dairy composition, typically as the matrix of the composition. Such compositions are known by the one skilled in the art. They can be for example fermented dairy products, for example fermented milk products, such as yogurts. Such products comprise lactic acid bacteria. The pH of such fermented dairy products can typically be of from 3.0 to 4.5, preferably of from 3.5 to 4.5. In one embodiment the composition is a non-fermented milk, supplemented with the fibers. Dairy compositions usually comprise milk, typically animal milk. The animal milk is typically cow milk, but one can use alternative animal milks such as sheep milk or goat milk. One can use milk substitutes, also referred to as vegetal milk, for example soya milk. Milks, either animal or vegetal typically comprise proteins (at least 1% by weight). Animal milk for example typically comprises casein. Any type of animal milk can be used, such as full milk, partially or totally skimmed milk, skimmed milk powder etc. The milk present in the composition can be introduced completely or partly in a milk powder form.

In one embodiment the composition is milk, typically as the matrix, supplemented with the fibers. In one embodiment the composition is skimmed milk, typically as the matrix, supplemented with the fibers. In one embodiment the composition is half skimmed milk, typically as the matrix, supplemented with the fibers. In one embodiment the composition is soy milk, typically as the matrix, supplemented with the fibers. In one embodiment to composition is a fermented milk, for example a low viscosity fermented milk, typically as the matrix, supplemented with the fibers.

In one embodiment the composition is a carbonated or non carbonated beverage. Examples of such compositions include for example colas, sodas, energy drinks, tea, ice-tea, flavored waters, functional waters, sparkling or still waters such as mineral waters, natural waters, source waters, purified waters.

In one embodiment the composition is a frozen composition. Examples of such compositions include sorbets, ice-creams and frozen yogurts. In one embodiment the composition is a solid food product. Examples of such compositions include cereals, cereal bars, and baked biscuits.

### FIBERS

The total concentration of fibers a), b) and c) in the composition can be for example of from 0.1 to 10 g, preferably of from 0.5 to 6 g, per 100 g of composition. In one embodiment the total concentration is of from 1.5 to 3 g, preferably from 1.5 to 2.5 g, or from 2.5 to 3 g of from 3 to 3.5 g, per 100 g of composition, typically after production and/or after a self-life at an appropriate temperature. Herein amounts of fibers can refer to amounts of fibers introduced as reported by fibers suppliers, or to amounts of fibers actually measured from the composition, for example by liquid chromatography such as HPAEC-PAD analysis. The total amount of fibers can be determined for example by the AOAC 2001.03 method.

The shelf life and the appropriate temperature can depend on the composition. For example many dairy products are to be stored at chilled temperature of form 0.5 to 10° C. Frozen products are to be stored at a frozen temperature of from −0.5° C. to −25° C., preferably −15° C. to −25° C. For example the self life and the temperature can be as follows:
shelf life: 30 days—room temperature, for example 25° C.,
shelf life: 2 mounts—room temperature, for example 25° C.,
shelf life: 3 mounts—room temperature, for example 25° C.,
shelf life: 6 mounts—room temperature, for example 25° C.,
shelf life: 9 mounts—room temperature, for example 25° C.,
shelf life: 12 mounts—room temperature, for example 25° C.,
shelf life: 30 days—temperature of from 0.5 to 10° C.,
shelf life: 2 mounts—temperature of from 0.5 to 10° C.,
shelf life: 3 mounts—temperature of from 0.5 to 10° C.,
shelf life: 6 mounts—temperature of from 0.5 to 10° C.,
shelf life 12 months—temperature of from −0.5° C. to −25° C., preferably −15° C. to −25° C.

Depending on the total amount of fibers, the compositions can be labeled as containing fibers or as source of fibers or as rich in fibers.

Fiber a) is fructo-oliqosaccharide. In the present specification this term also encompasses fibers referred to as hydrolyzed inulin, oligofructose or oligofructan. Fiber a) is also referred to as “FOS” herein. FOS is known by the one skilled in the art. FOS is typically comprised of linear chains of fructose units, linked by beta(2->1) fructosyl-fructose glycosidic bounds. The degree of polymerization of the chains can be of from 2 to 60, for example of from 3 to 6, or of from 6 to 8, or of from 8 to 10, or of from 10 to 15, or of from 15 to 60. In one embodiment the oligofrutose has glucose units at one or two chain ends. FOS can be produced by hydrolysis of inuline. In one embodiment one uses short chain FOS, having a polymerization degree of lower than 6, for example from 3 to 5. Short chain FOS can be produced by fermentation of sugar. Examples of suitable FOS are described in document EP1259125. Examples of useful FOS include FOS available at Beneo Orafti, such as Orafti P95. As other fructan compounds, FOS provides rapid, proximal and complete fermentation in the colon, associated with an osmotic activity. This colonic behavior also can provide a quick generation of side-effects, such as a laxative, bloating and/or flatulence effect, but the mixture of fibers of the invention allows a synergistic mitigation of these undesired side-effects.

Fiber b) is resistant dextrin or maltodextrin. These are typically produced by hydrolysis or partial hydrolysis of starches, such as wheat starch or corn starch. These typically consist of D-glucose units connected in chains of variable length. The glucose units are typically primarily linked with alpha(1->4) glycosidic bonds. One can use compounds with a dextrose equivalent of from 3 to 10 or of from 10 to 20. Resistant dextrin or maltodextin is well known by the one skilled in the art. It is mentioned that dextrin or maltodextin are fully digestible compounds and are considered as sugars, whereas resistant dextrin or maltodextin are not fully digestible compounds, being typically partially digestible compounds, and are considered as fibers. Examples of useful resistant dextrin fibers are for example fibers available at Roquette as Nutriose fibers. Another example of a useful resistant dextrin fiber is Fibersol-2 marketed by ADM Matsunami: Typically these fibers are very slowly, gradually and not completely fermented all along the colon.

Fiber c) is polydextrose. These are synthetic fibers comprised of highly branched chains of dextrose units. Polydextrose is also referred to as Poly-D-glucose or “E1200”. The degree of polymerization can be typically of from 3 to 30, preferably of from 3 to 20. Polydextrose is well known by the one skilled in the art. Examples of useful polydextrose fibers are for example polydextrose fibers available at Tate & Lyle, such as STA-LITE III.

Because of its highly branched nature, polydextrose is slowly and not completely fermented in proximal and transverse colon. This colonic behavior is responsible for moderate side-effects, but the mixture of fibers of the invention allows a synergistic mitigation of these undesired side effects.

The relative amounts of fibers a), b) and c) are as follows:
from 1% to 98% of fiber a),
from 1% to 98% of fiber b), and
from 1% to 50% of fiber c), the total of fibers a) b) and c) being 100%.

Preferably the relative amounts of fibers a), b) and c) are as follows:
from 1% to 98% of fiber a),
from 1% to 98% of fiber b), and
from 1% to less than 30% of fiber c).

Preferably the relative amounts of fibers a), b) and c) are as follows:
from 30% to 50% of fiber a)
from 40% to 60% of fiber b)
from 1% to 20% of fiber c).

The relative amounts of fibers can be determined for process information with information provided by fibers suppliers, or from the composition by analysis the amount of each fiber, for example by liquid chromatography analysis, preferably liquid chromatography with ion exchange, such as HPAEC-PAD chromatography analysis.

As mentioned above, it is not excluded that the composition comprises further fibers. Such further fibers do not account in the relative amounts above. Such further fibers can for example represent from 0% to 100% of the total amount of fibers a), b) and c).

The compositions can include some ingredients further to the fibers. These further ingredients can be part of the matrix. Examples of further ingredients include for example sugar, sweeteners, flavors, coloring agents, stabilizers, viscosifying agents such as starches or xanthan gum, pH modifying agents such as citric acid or ascorbic acid, etc.

### PROCESS

The composition can be prepared by any suitable process. The process typically comprises a step of mixing fibers a), b) and d). Preferably the fibers are mixed with a matrix, or with ingredients of a matrix, preferably a liquid matrix. Typically the fibers are added into the matrix. The mixture of fibers has been found to be highly soluble.

The association of fibers in the composition of the invention is particularly practical, and present good stability, good organoleptic properties, efficient dissolution, when processing, with substantially no undesired heterogeneity. It has been found that there is no significant degradation in various matrixes. It has been found that the association of the fibers proved especially practical for various matrixes and thus presents a high versatility.

### CONTAINER

The composition of the invention is typically contained in a container. It is conditioned appropriately at the end of the composition preparation process, by substantially filling the container with the composition, and then typically sealing the container.

The container is typically a container appropriate for pouring the product from the container. It has typically a form such as it is more high (vertical, top to bottom) than wide (longer horizontal dimension of the section, for example diagonal, diameter). The container has preferably a form factor between height and width of at least 1, preferably of at least 1.2, preferably of at least 1.5, preferably of at least 2.

Typically the container has a pouring mean, or can be modified to present a pouring mean, said pouring mean being preferably a neck, a corner or a spout. The pouring mean is preferably located at the top of the container.

The container can be in any appropriate material, for example plastic, such as polystyrene, or paperboard, or a combination thereof. It can be for example in a layered material having a paperboard layer a plastic layer, and optionally an aluminum foil. The container can be for example a plastic bottle or a brick carton. The container can be for example a 125 ml or 125 g container, a 200 ml or 200 g container, a 250 ml or 250 g container, a 500 ml or 500 g container, a 750 ml or 750 g container, a 1 l or 1 kg container, or a 1.5 l or 1.5 kg container.

### USES

The composition of the invention can be typically used as a food product, by oral administration. The subjects using the compositions are typically mammals, more typically humans. The subjects can be males and/or females, typically human males and/or human females.

The composition of the invention can be used to provide some digestive comfort. For example the composition can be used for the following effects:
treating and/or preventing digestive disorders,
reducing digestive discomfort,
improving digestive health
improving transit, for example reducing transit time and/or increasing stool frequency,
improving transit, for example reducing transit time and/or increasing stool frequency, for elderly subjects,
treating and/or reducing and/or preventing constipation,
reducing and/or preventing constipation, for elderly subjects,
reducing bloating or bloating feeling,
reducing flatulence,
reducing gas,
reducing belly distension or belly distention feeling,
improving bowel function,
maintaining bowel functionality,
regulating bowel movement,
modifying intestinal or gastrointestinal conditions,
increasing tolerance to fibers, and/or
reducing fibers side effects.

It is mentioned that some of these effects can be cumulated, and can overlap. Herein elderly subjects can refer to subjects being at least 65 years old, preferably at least 70 years old, for example at least 75 years old, for example at least 80 years old.

The compositions can be used by healthy subjects or by subject presenting a digestive condition such as Irritable Bowel Syndrome (IBS).

The invention also relates to a method of providing digestive comfort and/or at least one the effects listed above, by oral administration of the composition. The invention also relates to the composition for use to provide digestive comfort and/or at least one of the effects listed above. The invention also relates to the use of the mixture of fibers to provide digestive comfort and/or at least one of the effects mentioned above. The invention also relates to a method of providing digestive comfort and/or one of the effects mentioned above, by oral administration of the mixture of fibers. The invention also relates to the mixture of fibers for use to provide digestive comfort and/or at least one of the effects listed above. The invention also relates to a method of orally delivering a significant quantity of fibers, without providing side effects, such as reflux sensation, eructation, bloating, colic, heartburn, burning in the stomach, burning epigastric pain, abdominal pain, abdominal distension, borborygmus, meteorism, flatulence, nausea, difficulty in evacuation, pain to evacuate, vomit, or several of these side effects. For example the association of fibers of the invention can be delivered in an amount of up to 15 g per day, preferably up to 10 g per day, for example in an amount of from 5 to 10 g per day, for example 8 to 9 g per day. The total concentration of fibers a), b), and c) in the composition, and/or the serving size as provided by the container size and/or instruction of optimal use, can be adapted to meet the amounts of fibers per day.

Further details or advantage of the invention might appear in the following non limitative examples.

### EXAMPLES

The following ingredients are used:
Orange matrix: Orange nectar having a brix degree of 12.
Grape matrix: Grape nectar having a brix degree of 13.
Peach matrix: Peach nectar having a brix degree of 12.
Milk Matrix: standard milk
Half Milk Matrix: standard half milk
Soy Milk Matrix: standard soy milk
Fermented milk matrix: low viscosity milk fermented with lactic acid bacteria
FOS: Orafti P95, marketed by Beneo Orafti
Restistant dextin: Nutriose FB06, marketed by Roquette Freres
Polydextrose: Sta-lite Ill, marketed by Tate & Lyle.

### Examples 1 to 7

The following compositions are prepared by mixing the fibers into the matrix. The amounts of fibers are provided as % by weight of active from the ingredient.

| | Example 1 | Example 2 | Example 3 |
|---|---|---|---|
| | Orange nectar | Grape nectar | Peach nectar |
| Matrix | Orange matrix | Grape matrix | Peach matrix |
| FOS | 1.19% | 1.19% | 1.19% |
| Resistant dextrine | 1.03% | 1.03% | 1.03% |
| Polydextrose | 0.26% | 0.26% | 0.26% |
| Other ingredients | Citric acid, | Citric acid, | Citric acid, |
| | beta-carotene, | flavors, | ascorbic acid; |
| | flavors | Xanthan gum | flavors |
| pH | 3.5 | 3.0 | 3.5 |

### Evaluations

The amount of the fibers is evaluated by HPAEC-PAD chromatography analysis after a self life of 3 months at room temperature (25° C.). The results are as follows:

| | Example 1 | Example 2 | Example 3 |
|---|---|---|---|
| | Orange nectar | Grape nectar | Peach nectar |
| FOS | 0.8% | 0.8% | 0.8% |
| Resistant dextrine | 0.95% | 0.95% | 0.95% |
| Polydextrose | 0.25% | 0.25% | 0.25% |

The compositions of examples 1 to 3 are stable and do not present phase separation or agglomeration of the fibers.

| | Example 4 | Example 5 | Example 6 |
|---|---|---|---|
| | Milk | Skimmed Milk | Soy milk |
| Matrix | Milk matrix | Skimmed | Soy |
| | | milk matrix | milk matrix |
| FOS | 1.19% | 1.19% | 1.19% |
| Resistant dextrine | 1.03% | 1.03% | 1.03% |
| Polydextrose | 0.26% | 0.26% | 0.26% |

| | Example 7 |
|---|---|
| | Fermented Milk |
| Matrix | Milk matrix |
| FOS | 1.44% |
| Resistant dextrine | 1.25% |
| Polydextrose | 0.31% |

The compositions of examples 4 to 7 are stable and do not present phase separation or agglomeration of the fibers.

### Example 8

### Clinical Evaluation

Tolerance of a studied product was investigated in a monocentric double blind randomized two parallel arms controlled placebo study, with the following participants: Participants: 200 healthy women from 18 to 45 years, without functional digestive disorders or diagnosed digestive disease.

The tested products were the following (amounts per 100 g)

| | Studied Product: | |
|---|---|---|
| | Orange juice with fibers | Control |
| Water | To 100 g | To 100% |
| Orange juice concentrate | 7.3 g | 7.3 g |
| Sugar | 7.7 g | 7.7 g |
| Flavor | 0.0025 g | 0.0025 g |
| Citric acid | 0.25 g | 0.25 g |
| FOS | 1.06 g | / |
| Resistant dextrin | 1.25 g | / |
| Polydextrose | 0.29 g | / |

Participants were asked to consume 2 portions of 200 ml per day of the studied product or of the control, during 21 days and to evaluate undesired side effects under a score scale.

Results were as follows:
There was no substantial and/or statistical difference between the control group and the studied product group as to reflux sensation, eructation, bloating, colic, heartburn, burning in the stomach, burning epigastric pain, abdominal pain
There was no difference no substantial and/or statistical difference between the control group and the studied product group as to abdominal distension, borborygmus, meteorism, flatulence, nausea, difficulty in evacuation, pain to evacuate, vomit.

The studied product did not generate side effects, as compared to the control, despite the high fiber intake.

1. A composition comprising: a mixture of the following fibers a), b) and c):
fiber a): Fructo-oligosaccharide,
fiber b): resistant dextrin or maltodextrin,
fiber c): polydextrose,
wherein the relative amounts by weight of fibers a), b) and c), with reference to the total amount by weight of fibers a), b) and c) are:
from 1% to 98% of fiber a),
from 1% to 98% of fiber b), and
from 1% to 50% of fiber c),
the total amount of fibers a), b) and c) being 100%.

2. A composition according to claim 1, wherein the relative amounts by weight of fibers a), b) and c), with reference to the total amount by weight of fibers are:
from 1% to 98% of fiber a),
from 1% to 98% of fiber b), and
from 1% to less than 30% of fiber c).

3. A composition according to claim 1, wherein the relative amounts by weight of fibers a), b) and c), with reference to the total amount by weight of fibers are:
from 30% to 50% of fiber a),
from 40% to 60% of fiber b), and
from 1% to 20% of fiber c).

4. A composition according to claim 1, wherein the total concentration of fibers a), b) and c) in the composition is from 0.1 to 10 g, preferably from 0.5 to 6 g, per 100 g of composition.

5. A composition according to claim 4 wherein the total concentration is from 1.5 to 3 g per 100 g of composition.

6. A composition according to claim 1, wherein the composition is a fruit juice.

7. A composition according to claim 6, wherein the fruit juice is an orange fruit juice, a peach fruit juice, a grape fruit juice, an apple fruit juice, a banana fruit juice, or a mixture of fruit juices comprising at least one of these fruit juices.

8. A composition according to claim 6; wherein the fruit juice has a Brix degree of from 10 to 20.

9. A process of making a composition according to claim 1, comprising: mixing fibers a), b) and c).

10. The use of the composition according to claim 1, a food product, by oral administration.

11. A method of providing digestive comfort comprising an oral administration of the composition according to claim 1.
